(19) United States
(12) Patent Application Publication
(10) Pub. No.: US 2006/0166577 A1
(43) Pub. Date: Jul. 27, 2006

(54) Scrim made of twill-woven thermoplastic tapes

(76) Inventor: Mohamed Abdel Aziz Rashed, Abbotsford (CA)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 10/517,794

(22) PCT Filed: Jun. 11, 2003
(86) PCT No.: PCT/CA03/00895

§ 371 Date: Jul. 18, 2005

(30) Foreign Application Priority Data
Jun. 11, 2002 (CA) 2,390,280

(51) Int. Cl. D04G 1/00; D04H 1/00; B32B 27/12; B32B 5/02

(52) U.S. Cl. 442/1; 442/2; 442/131; 442/136; 442/38

(57) ABSTRACT

An industrial-strength scrim is made of thermoplastic tapes woven together in a twill weave, in which the weft tapes cross over at least two successive warp tapes and under at least one successive warp tape, in a repeating pattern. Such weave permits more tapes per inch to be accommodated in the scrim than for a plain weave, producing a scrim having greater mechanical strength, less cramming and folding of tapes and a smoother surface with fewer voids, suitable for coating.

### TECHNICAL FIELD

The invention pertains to a twill-woven scrim made from thermoplastic tapes, suitable for use in fabricating heavy industrial fabric such as building covers, hay tarps, steel and lumber wraps and other products.

### BACKGROUND

It is known in the field of industrial strength fabrics to make a woven scrim from thermoplastic tapes. Such tapes, commonly made of polyolefins such as high density polyethylene and stretched in the course of manufacture, are flexible, weavable and have high tensile strength. Scrims woven of such tapes have substantial mechanical strength and are used as a structural element of industrial fabrics such as tarpaulins, building covers, wrapping materials for industrial goods, and similar uses. The strength of such scrims is affected by the number of tapes per inch that can be woven together and the strength of the tapes.

In prior art scrims, the weave used is a plain weave, in which each weft tape crosses over and under successive warp tapes, one at a time. Such weave maximizes the number of tape crossings per unit of length. It also limits the number of tapes per inch that can be accommodated into the weave without cramming or folding of the tapes. Forcing more tapes into a plain weave than will readily fit side-by-side causes cramming or folding of the tapes, creating fibrillation or splitting of tapes, which causes reduction of tensile strength.

It would be desirable to provide a weave which can accommodate more tapes per inch than a plain weave, and therefore provide a scrim having greater strength, while avoiding the problems that arise by introducing excess tapes into a plain weave.

### SUMMARY OF INVENTION

It is an object of the invention to provide a scrim made of thermoplastic tapes that has higher mechanical strength than a scrim made with plain weave, by accommodating more tapes per inch.

It is a further object of the invention to provide a scrim that is heavier, more durable and more wrinkle resistant than plain weave scrims.

It is also an object of the invention to provide a scrim that has a dimensionally stable and flat surface that is readily coated.

These and other objects are achieved by means of a scrim comprising tapes having a twill weave. Such weave is known in the fabric industry for the purpose of forming decorative ribs on the surface of fabrics by means of a weaving process in which a weft thread passes over two or more successive warp threads before weaving under, with the point of intersection moving at least one outward for each succeeding weft thread.

The present inventors have discovered that a twill weave can be used for making scrims of thermoplastic tapes, and that such weave imparts important functional advantages to the scrim. The use of a twill weave results in fewer crossings-over of a weft tape from above a warp tape to below one, per unit of length, permitting more tapes per inch to be woven into the scrim, as compared with a scrim woven from the same tape using a plain weave. The resulting scrim is therefore more durable and heavier than a plain weave scrim using the same size and type of tapes. Using the twill weave, the scrims of the invention can incorporate a number of tapes per inch that, in a plain weave, would produce cramming or folding of tapes, and reduces tensile strength.

These and other objects, advantages and features of the invention will be apparent from the following description of the preferred embodiments, considered with the accompanying drawings.

### BRIEF DESCRIPTION OF DRAWINGS

FIG. 1 is an enlarged plan view of a two by two twill-woven scrim according to the invention.

FIG. 2 is an enlarged plan view of a three by three twill-woven scrim according to the invention.

FIG. 3a is an enlarged plan view of a two by one left-handed twill-woven scrim according to the invention.

FIG. 3b is an enlarged plan view of a two by one right-handed twill-woven scrim according to the invention.

FIG. 4 is a plan view of a four by four twill-woven scrim according to the invention.

FIG. 5 is a plan view of a one by three twill-woven scrim according to the invention.

FIG. 6 is a plan view of a one plus two by two plus one twill-woven scrim according to the invention.

FIG. 7 is a plan view of a one plus three by three plus one twill-woven scrim according to the invention.

### DESCRIPTION OF THE PREFERRED EMBODIMENTS

The warp and weft tapes that are the structural elements of the scrims of the invention are thermoplastic tapes of a size and strength suitable for the manufacture of industrial strength scrims. In this specification, “tape” means a flexible, weavable, elongated member with a rectangular cross-section, having a width at least ten times larger than its thickness. The width of the tapes is preferably in the range of one to ten millimeters. The thickness of the tapes is preferably in the range of 0.02 to 0.1 mm. The weight of the tapes (measured as decitex, i.e. weight in grams per 10,000 meters in length) is preferably in the range of 500 to 3,000. The tapes can be made by slitting cast-extruded thermoplastic film into strands and stretching them from three to five times their original length. Tapes are preferably made of polyolefin material, such as high density polyethylene or polypropylene. Such tapes are flexible, weavable and have high tensile strength.

The tapes for use in the invention can contain one or more of various additives, to impart properties to the scrim that are useful for particular applications. For example, they can contain color pigments, such as black pigment, to increase the resistance of the scrim to UV radiation, or pigments or compositions to increase reflectivity. They can contain UV-resistant compositions or flame-retardant compositions.

The tapes are woven in various of twill weave and mixtures of twill and plain weave, as described below, using conventional tape-weaving equipment. Different styles of twill weave affect the maximum pick count, i.e. the number of tapes per unit of length, and therefore the strength and characteristics of the scrim. The drawings show a selection of representative twill weave patterns that can be used for the scrims of the invention.

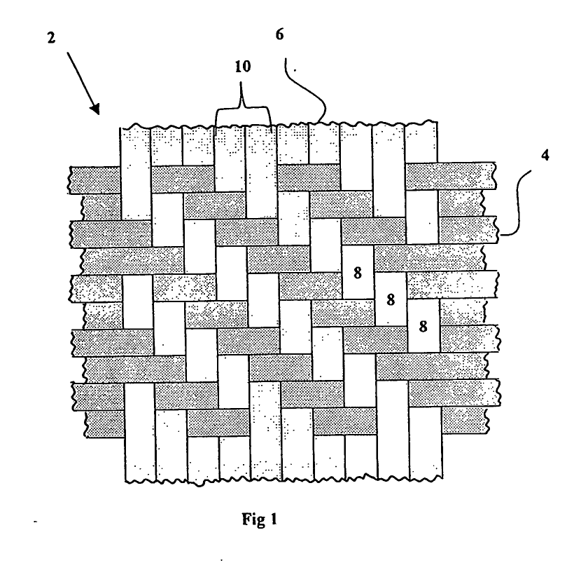

FIG. 1 shows a two by two twill weave. In scrim 2, weft tapes 4 and warp tapes 6 each comprise a set of tapes in a substantially parallel, side-by-side relationship, with the weft tapes substantially perpendicular to the warp tapes. Weft tape 4 passes alternatively over two and under two successive warp tapes 6 repeatedly, with the point of intersection being shifted by one warp tape for each successive weft tape. Likewise, warp tapes 6 pass over two and under two successive warp tapes repeatedly, the point of intersection shifting by one weft tape for each successive warp tape. The crossings-over 8 by the warp tapes thus collectively form a plurality of visible bands 10 running obliquely relative to the direction of both the warp tapes and the weft tapes, which are perpendicular to each other. The bands 10 are visible surface features on the scrim and are simply the natural result of the twill weave. They are not significant protrusions on the scrim, the surface being substantially smooth and flat. The reverse side of the scrim (not shown in the drawings) likewise has a plurality of oblique bands, formed of the crossings-over of the warp tapes as seen from that side of the scrim.

It will be understood that, for the purposes of the invention, it is immaterial whether the crossings-over that form the bands 10 are crossings-over of the warp tapes or the weft tapes: what is required is that, of the two sets of mutually perpendicular tapes, the tapes of one set form crossovers relative to the other.

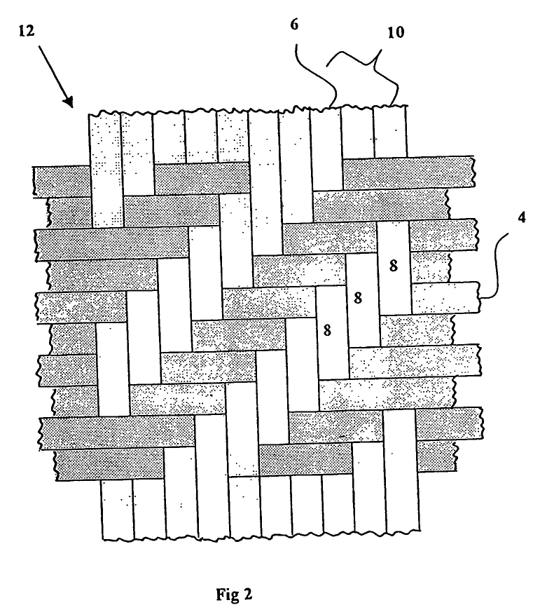

Referring next to FIG. 2, there is shown a scrim 12 comprising warp tapes 6 and weft tapes 4 in a three by three twill weave. Weft tape 4 passes over three then under three successive warp tapes, repeatedly, with the point of intersection being shifted by one warp tape for each successive weft tape. The crossings-over 8 by the warp tape are accordingly longer than for the two by two weave of FIG. 1, forming a band 10 that is wider than the corresponding band in the two by two weave.

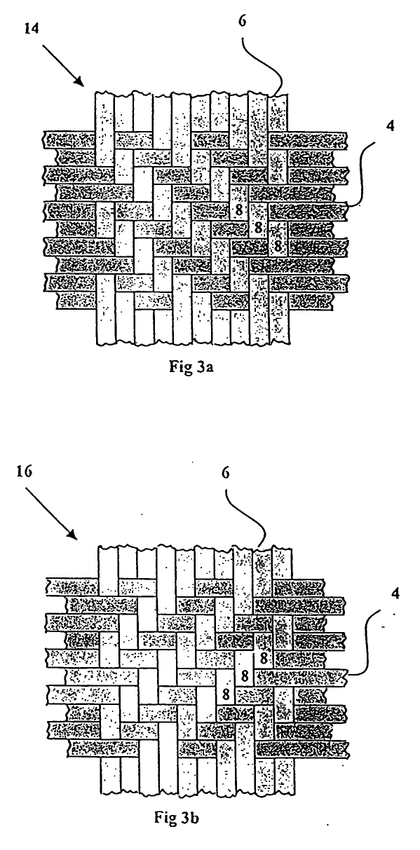

FIGS. 3a and 3b show two variations of a two by one weave. In FIG. 3a, weft tape 4 of scrim 14 crosses over two and under two successive warp tapes 6 repeatedly. Cross-overs 8 by the warp tape 6 form a band running downward from left to right (in the view of FIG. 3a. In FIG. 3b, weft tapes 4 of scrim 16 cross over two and under two successive warp tapes 6 repeatedly. Here the cross-overs 8 by the warp tapes form a band running from the lower left to the upper right. It will be understood that, for the purposes of the invention, it is immaterial whether the bands 10 run upward from left to right (referred as to as a right-handed twill weave) or downward from left to right (referred to as a left-handed twill weave). That attribute is simply a function of the direction in which the weaving pattern is shifted for each successive weft tape (i.e. one warp to the right (in the upward direction of FIG. 3) for a right-handed twill weave, or the reverse for a left-handed twill weave). The functional attributes described herein that are imparted to the woven scrim by means of a twill weave are the same for both. All the twill-woven scrims of the invention can be either right- or left-handed weaves.

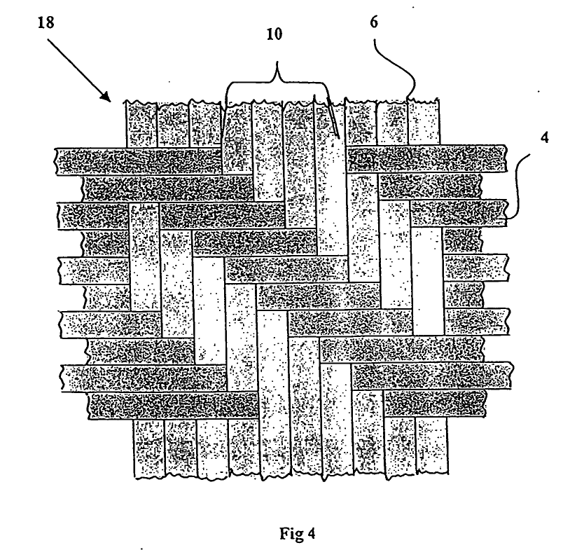

FIG. 4 shows a scrim having a four by four twill weave. In scrim 18, weft tape 4 crosses over four and then under four successive warp tapes 6, repeatedly, with the point of intersection shifting by one warp tape for each successive weft tape. Cross-overs 8 of the warp tape form bands 10.

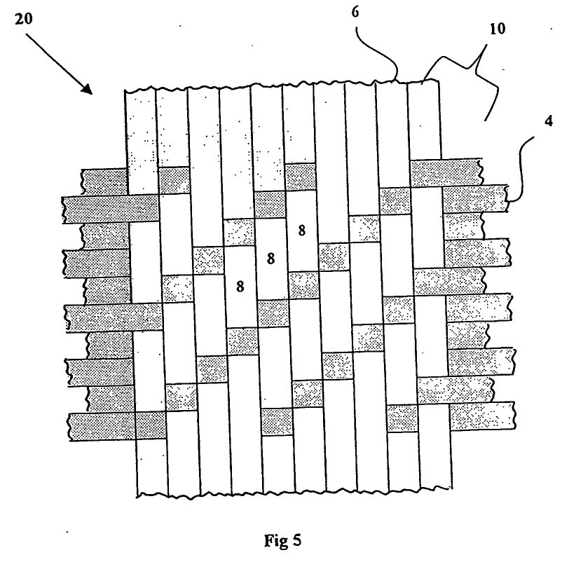

FIG. 5 shows a scrim having a one by three twill weave. In scrim 20, weft tape 4 crosses over one and under three warp tapes 6 repeatedly, with the point of intersection shifting by one warp tape for each successive weft tape. Cross-overs 8 of the warp tapes form bands 10.

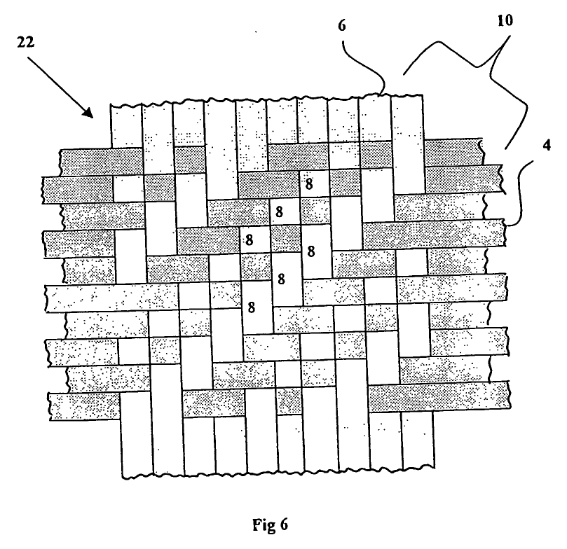

FIG. 6 shows a scrim having a one plus two by two plus one twill weave. In scrim 22, weft tape 4 passes over one, under two, over two and under one warp tapes, repeatedly, with the point of intersection shifting by one warp tape for each successive weft tape. The cross-overs 8 of the warp tapes form double bands, having a single and double cross-over spaced apart.

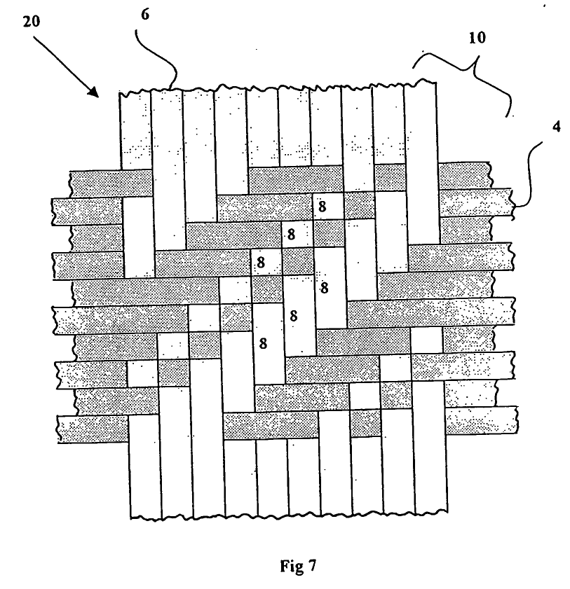

FIG. 7 shows a scrim having a one plus three by three plus one twill weave. In scrim 24, weft tape 4 crosses over one, under three, over three and under one warp tapes, repeatedly, with the point intersection shifting by one warp tape for each successive weft tape. The cross-overs 8 of the warp tapes form double bands 10, having a single and triple cross-over spaced apart.

The various twill weaves shown in the drawings are only examples of the many other twill weave patterns that can be used for the scrims of the invention. What they all have in common is that, as in all twill weaves, a weft tape crosses over two or more successive warp tapes before crossing under one or more successive warp tapes.

In order to strengthen the scrims for certain applications, reinforcing tapes or reinforcing threads can be included in the twill weaves, in various manners. Reinforcing tapes or threads are preferably made of stronger material than the warp and weft tapes of the scrim. They may be made, for example, of polyester resin, though they may also be made of polyolefins. Reinforcing threads may be cylindrical or non-cylindrical in cross-section. Reinforcing tapes are the same shape as the warp and weft tapes. They may be grouped with individual warp and/or weft tapes, such that a reinforcing tape or thread is woven side by side with and in the same weaving path as a given weft or warp tape, or reinforcing tapes or threads may be used in place of some warp or weft tapes. It is particularly preferred to replace several of the warp tapes proximate to the outer edges of the scrim by reinforcing tapes or threads, to strengthen the edges of the scrim.

### EXAMPLE

A tape made of high density polyethylene 3.3 mm wide and 48 micrometers thick, having a decitex of 1705 was woven into scrims of a variety of woven patterns on a Sulzer (trademark) weaving machine. For a plain weave scrim, the maximum pick count that could be achieved without splitting tapes was 16 tapes per inch in both directions, and a maximum scrim weight of 230 grams per square meter. Various twill weaves were made. The results are summarized in Table 1. It was found that the pick count was increased by from 35 to 45 percent, depending on the specific twill weave used, increasing the scrim weight up to 334 grams per square meter.

In Table 1, where the twill weave style is denoted by two numbers, the first number indicates the number of successive warp tapes the weft tapes pass over, and the second number indicates the number of successive warp tapes the weft tapes pass under, in each repeating unit of the pattern. For example, 2/2 indicates the weave shown in FIG. 1. Where the twill weave style is denoted by four numbers, the numbers indicate, in order, the numbers of successive warp tapes the weft tapes pass over, then under, then over, then under, respectively, in each repeating unit of the pattern. For example, 1+2/2+1 indicates the weave shown in FIG. 6.

TABLE 1

| | Percent of Additional | Weight of Scrim |
|---|---|---|
| Twill | Picks Compared | (grams per |
| Weave Style | with Plain Weave | square meter) |
| 2/2 | 35% | 311 |
| 3/3 | 40% | 322 |
| 4/4 | 45% | 334 |
| 1/3 | 40% | 322 |
| 3/1 | 40% | 322 |
| 2/3 | 40% | 322 |
| 4/2 | 45% | 334 |
| 1 + 2/2 + 1 | 35% | 311 |
| 1 + 3/3 + 1 | 40% | 322 |

Scrims made with a twill weave as described above were found to accommodate up to 45 percent more tapes per inch as compared with plain weave scrims made from the same kind of tapes. They therefore have higher mechanical strength and are heavier than plain weave scrims made from the same tape. Due to having fewer crossings of the tapes per inch than the plain weave scrim, there is less tension on the tapes and therefore less tendency for the tapes to fibrillate, a defect that decreases the durability and strength of a scrim.

The scrims of the invention were also found to have, relative to plain weave scrims made with the same tapes, less cramming and folding of the tapes and therefore a smoother surface with fewer voids. Such surface is more suitable for coating by an extruded or laminated film, with a reduced incidence of pinholes in the coated scrim. It will be understood that lengthwise folding and rolling of the tapes does occur with the twill weaves of the present invention, but such folding and rolling results in relatively smooth tapes which tend not to fold or cram on top of each other, producing a smoother scrim surface.

Scrims of the invention can be laminated on one or both sides with thermoplastic films, using conventional laminating processes, to produce waterproof fabrics suitable for use as industrial fabrics, construction fabrics, building covers, tarpaulins, landfill covers, agricultural fabrics (such as hay tarps), wrapping materials and for other industrial and agricultural applications.

The film to which the scrim is laminated preferably comprises polyolefin resin, such as polyethylene or polypropylene, and may include optional additives such as UV-resistant compositions and flame-retardant compositions.

The scrims of the invention may also be used as the structural substrate for a wide range of laminated products, in the same manner as prior art plain weave scrims are used, but bringing the advantages of a superior scrim, as described above. For example, they may be laminated on one or both sides to a layer of slip-resistant material, or to a layer of water-absorbent material, such as paper or non-woven thermoplastic fibres. Such laminated products can be used as industrial and agricultural fabrics for a variety of purposes, including those described above. Uncoated or unlaminated scrim according to the invention can also be used for a variety of applications, such as industrial fabrics, construction fabrics, landfill covers, etc.

Although the invention has been described in terms of various embodiments, it is not intended the invention be limited to these embodiments. Various modifications within the scope of the invention will be apparent to those skilled in the art. The scope of the invention is defined by the claims that follow.

1. A woven scrim made of thermoplastic tapes, said tapes being woven so as to form a plurality of oblique bands on a surface of said scrim, comprising:
(a) a first set of tapes generally parallel to each other;
(b) a second set of tapes generally parallel to each other and perpendicular to said first set of tapes;
(c) said tapes in said first set forming a repeating pattern of units comprising crossings-over and crossings-under of said tapes of said second set, each of said units comprising a sequential crossing-over of at least two and crossing-under of at least one, successive tapes in said second set;
(d) said pattern, with respect to each successive tape in said first set, being shifted in position by at least one tape of said second set; and
(e) said crossings-over of said tapes of said first set collectively forming said oblique bands on said surface of said scrim.

2. A woven scrim according to claim 1 wherein each of said units comprises a sequential crossing-over of two and crossing-under of two successive tapes in said second set.

3. A woven scrim according to claim 1 wherein each of said units comprises a sequential crossing-over of three and crossing-under of three successive tapes in said second set.

4. A woven scrim according to claim 1 wherein each of said units comprises a sequential crossing-over of four and crossing-under of four successive tapes in said second set.

5. A woven scrim according to claim 1 wherein each of said units comprises a sequential crossing-over of three and crossing-under of one successive tapes in said second set.

6. A woven scrim according to claim 1 wherein each of said units comprises a sequential crossing-over of one and crossing-under of two and crossing-over of two and crossing-under of one successive tapes in said second set.

7. A woven scrim according to claim 1 wherein each of said units comprises a sequential crossing-over of one and crossing-under of three and crossing-over of three and crossing-under of one successive tapes in said second set.

8. A woven scrim made of thermoplastic tapes, comprising:
(a) a plurality of warp tapes in a substantially parallel side-by-side relationship;
(b) a plurality of weft tapes in a substantially parallel side-by-side relationship;
(c) said warp tapes and said weft tapes being woven together in a twill weave.

9. A woven scrim according to claim 8 wherein said tapes have a width in the range of 1 to 10 mm.

10. A woven scrim according to claim 8 wherein said tapes have a thickness in the range of 0.02 to 0.1 mm

11. (canceled)

12. (canceled)

13. A woven scrim according to claim 8 wherein said tapes comprise polyolefin resin.

14. (canceled)

15. (canceled)

16. (canceled)

17. (canceled)

18. A woven scrim according to claim 8 wherein said scrim further includes reinforcing threads or reinforcing tapes grouped with at least some of said tapes of said scrim.

19. A woven scrim according to claim 8 wherein said scrim further includes reinforcing threads or reinforcing tapes replacing at least some of said tapes of said scrim.

20. A woven scrim according to claim 18 wherein some of said tapes are warp tapes and said reinforcing threads or reinforcing tapes replace at least some of said warp tapes.

21. A woven scrim according to claim 20 wherein said reinforcing threads or reinforcing tapes replace at least some of said warp tapes proximate to outer edges of said woven scrim.

22. A woven scrim according to claim 18 wherein said reinforcing tapes or reinforcing threads comprise polyolefin resin.

23. A woven scrim according to claim 18 wherein said reinforcing tapes or reinforcing threads comprise polyester resin.

24. A fabric comprising a woven scrim according to claim 8 laminated on one or both sides thereof to a waterproof thermoplastic film.

25. A fabric according to claim 24 wherein said film comprises polyolefin resin.

26. (canceled)

27. (canceled)

28. A fabric comprising a woven scrim according to claim 8 laminated on one or both sides thereof to a layer of slip-resistant material.

29. A fabric comprising a woven scrim according to claim 8 laminated on at least one side thereof to a metalized film.

30. A fabric comprising a woven scrim according to claim 8 laminated on one or both sides thereof to a layer of water-absorbent material.

31. A fabric according to claim 30 wherein said water-absorbent material is paper.

32. (canceled)

33. The use of the scrim of claim 8 as an industrial fabric, construction fabric or landfill cover.

34. The use of the fabric of claim 24 as an industrial fabric, tarpaulin, landfill cover, construction fabric or agricultural fabric.
